(19) United States
(12) Patent Application Publication
(10) Pub. No.: US 2025/0181758 A1
(43) Pub. Date: Jun. 5, 2025

(54) MIGRATING SENSITIVE DATA ACROSS CLOUD CONFIDENTIAL COMPUTING ENVIRONMENTS

(71) Applicant: International Business Machines Corporation, Armonk, NY (US)

(72) Inventors: Heng Wang, Beijing (CN); Hernan A. Cunico, Holly Springs, NC (US); Ming Zhe Jiang, Beijing (CN); Xiao Ling Chen, Beijing (CN)

(21) Appl. No.: 18/530,001

(22) Filed: Dec. 5, 2023

(51) Int. Cl. G06F 21/62; G06F 21/78

(52) U.S. Cl. CPC G06F 21/6245; G06F 21/78

(57) ABSTRACT

A computer-implemented method, according to one approach, includes: receiving a request to migrate sensitive data from a first volume in a first trusted TEE to a second volume in a second TEE. The computer-implemented method further includes generating migration metadata that outlines the sensitive data. The sensitive data is also extracted from the first volume. A new container image is created, such that the migration metadata and the sensitive data are packaged therein. Furthermore, the new container image is sent to the second TEE.

### BACKGROUND

The present invention relates to cloud confidential computing environments, and more specifically, this invention relates to migrating sensitive (and sometimes encrypted) data across cloud confidential computing environments.

The use of public and hybrid cloud services continues to expand over time, resulting in data privacy in cloud environments becoming increasingly important. In an attempt to address this, cloud providers have offered encryption services to help protect data while it is at rest (e.g., in storage and databases), as well as data that is in transit (e.g., moving over a network connection). However, encrypted data is decrypted while in use. For instance, before it can be processed by an application, data must be unencrypted in memory. This undesirably exposes sensitive information to exposure just before, during, and just after processing. Accordingly, it is desirable that confidential computing is able to provide greater assurances that data in cloud environments is protected and confidential.

### SUMMARY

A computer-implemented method, according to one approach, includes: receiving a request to migrate sensitive data from a first volume in a first trusted execution environment (TEE) to a second volume in a second TEE. The computer-implemented method further includes generating migration metadata that outlines the sensitive data. The sensitive data is also extracted from the first volume. A new container image is created, such that the migration metadata and the sensitive data are packaged therein. Furthermore, the new container image is sent to the second TEE.

A computer-implemented method, according to yet another approach, includes: receiving a container image from a remote TEE. In response to determining that the received container image includes migration metadata therein, the migration metadata is parsed. Sensitive data is also extracted from an uppermost layer of the container image. A second layer of the container image is set as an identification for the container image. The second layer of the container image is further used to generate a corresponding container, and the sensitive data is inserted into a read/write layer of the corresponding container.

A computer program product, according to another approach, includes a computer readable storage medium having program instructions embodied therewith. The program instructions are readable by a processor, executable by the processor, or readable and executable by the processor, to cause the processor to: perform any combination of the foregoing methodologies.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of the components in a distributed system, in accordance with one approach.

FIG. 2B is a detailed view of a component in FIG. 2A, in accordance with one approach.

FIG. 3A is a flowchart of a method, in accordance with one approach.

FIG. 3B is a flowchart of sub-operations for one of the operations in the method of FIG. 3A, in accordance with one approach.

FIG. 3C is a flowchart of a method in accordance with an in-use example.

FIG. 4 is a flowchart of a method, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for migrating highly sensitive (and sometimes encrypted) data across cloud confidential computing environments. As a result, approaches herein are desirably able to migrate sensitive data while maintaining security of the data itself, even in cloud confidential computing environments. As used herein, the term “sensitive data” may refer to any type of data for which access to the data is to be restricted and/or controlled in some way. This process of migrating sensitive data is made transparent to the end user after providing a migration trigger, so as not to impact the user experience. Furthermore, this can be accomplished in a TEE-independent manner, thereby significantly expanding applicability of the improvements achieved by approaches herein, e.g., as will be described in further detail below.

In one general approach, a computer-implemented method includes: receiving a request to migrate sensitive data from a first volume in a first trusted TEE to a second volume in a second TEE. The computer-implemented method further includes generating migration metadata that outlines the sensitive data. The sensitive data is also extracted from the first volume. A new container image is created, such that the migration metadata and the sensitive data are packaged therein. Furthermore, the new container image is sent to the second TEE.

It follows that various approaches herein are able to achieve data migration without exposing any sensitive information outside protected environments that provide trusted execution and/or storage regions. This has been conventionally unachievable. Approaches herein are even able to migrate sensitive data while maintaining security of the data itself in cloud confidential computing environments. This process is also made transparent to the end user after providing a migration trigger, so as not to impact the user experience. Furthermore, this can be accomplished in a TEE-independent manner, thereby significantly expanding applicability of the improvements achieved by approaches herein.

In some implementations, the migration metadata includes key-value character strings that identify the sensitive data requested to be migrated. It follows that the migration metadata may outline the sensitive data using key-value character strings. Key-value character strings provide an accurate understanding of the extents of the sensitive data requested to be migrated. This desirably reduces the likelihood of only a portion of the requested sensitive data being migrated, as well as reducing the likelihood of more sensitive data being migrated than was requested. Implementations herein are thereby able to effectively control access to sensitive data.

In some implementations, generating migration metadata that outlines the sensitive data includes identifying the sensitive data in the first volume requested to be migrated. The remaining sensitive data in the first volume that has not been requested to be migrated is also identified. A determination is made as to the difference between: the sensitive data in the first volume requested to be migrated, and the remaining sensitive data in the first volume not requested to be migrated. Furthermore, the determined difference is used to create the migration metadata.

Identifying sensitive data in the first volume that has been requested to be migrated, as well as identifying sensitive data in the first volume that has not been requested to be migrated achieves a detailed understanding of the data migration being performed. For instance, data that has been requested to be migrated may be compared against the data that has not been requested to be migrated to determine whether all data in the first volume is accounted for. This desirably avoids data loss issues, thereby further improving efficiency at which sensitive data can be migrated between protected environments.

In some implementations, the migration metadata and the sensitive data are packaged in an individual layer in the new container image. For instance, the migration metadata may be an image tag assigned to an uppermost layer of the new container image.

It follows that the TEE migration metadata and the extracted sensitive data may be included together in an individual layer of the new container image. In some situations, the individual layer is the uppermost layer of the new container image. This uppermost layer of the new image may serve as the image layer while layers below the uppermost image layer may be limited to read-only. Accordingly, the TEE migration metadata and the extracted sensitive data may be added to the uppermost image layer, as well as read therefrom, during use without impacting a remainder of the image. Similar functionality may also be achieved by assigning the migration metadata as a tag to the image itself, while the sensitive data is packaged in a layer of the image.

In some implementations, the operations are performed by a migration layer producer module in a container engine at the first TEE. Moreover, the container engine may include the migration layer producer module and a migration layer consumer module.

It follows that in some implementations, a container engine is able to generate TEE migration metadata and new container images as described herein based on received migration requests, as well as evaluate container images that are received from other locations. In other words, the container image is able to initiate a transfer of sensitive information to a remote protected environment, as well as complete a transfer of sensitive information received from a remote protected environment. For instance, the migration layer consumer module may be configured to receive a container image, extract sensitive information therefrom, and use the extracted information to create new containers at a target TEE by using the second layer of the received image.

In some implementations, the operations are performed by a migration layer producer module in a container engine at the first TEE. Moreover, the container engine may include the migration layer producer module and a migration layer consumer module. Additionally, the migration layer consumer module may be configured to receive a container image from a remote TEE, and parse migration metadata in an uppermost layer of the container image. The migration layer consumer module may be further configured to extract data from the uppermost layer of the container image. In response to extracting data from the uppermost layer of the container image, a second layer of the container image is set as an identification for the container image. Moreover, the second layer of the container image is used to generate a corresponding container. The extracted data is further inserted into a read/write layer of the corresponding container.

Again, a container engine that is able to evaluate container images received from other locations can complete a transfer of sensitive information between remote protected environments. Container engines corresponding to different protected environments may thereby achieve data migration without exposing any sensitive information outside the trusted execution and/or storage regions in the protected environments. Furthermore, this can be accomplished in a TEE-independent manner, thereby significantly expanding applicability of the improvements achieved by approaches herein.

In another general approach, a computer-implemented method includes: receiving a container image from a remote TEE. In response to determining that the received container image includes migration metadata therein, the migration metadata is parsed. Sensitive data is also extracted from an uppermost layer of the container image. A second layer of the container image is set as an identification for the container image. The second layer of the container image is further used to generate a corresponding container, and the sensitive data is inserted into a read/write layer of the corresponding container.

It follows that various approaches herein are able to achieve data migration without exposing any sensitive information outside protected environments that provide trusted execution and/or storage regions. This has been conventionally unachievable. Approaches herein are even able to receive and process migrated sensitive data while maintaining security of the data itself in cloud confidential computing environments. Furthermore, this can be accomplished in a TEE-independent manner, thereby significantly expanding applicability of the improvements achieved by approaches herein.

In some implementations, the container image is received at a local TEE from the remote TEE corresponding to a migration request. It follows that the operations may be performed by a migration layer consumer module in a container engine. The container engine may actually include the migration layer consumer module in addition to a migration layer producer module.

It follows that in some implementations, a container engine is able to evaluate container images that are received from other locations, as well as generate TEE migration metadata and new container images based on received migration requests. In other words, the container image is able to initiate a transfer of sensitive information to a remote protected environment, as well as complete a transfer of sensitive information received from a remote protected environment. For instance, the migration layer consumer module may be configured to receive a container image, extract sensitive information therefrom, and use the extracted information to create new containers at a target TEE by using the second layer of the received image.

In some implementations, the migration metadata includes key-value character strings that identify the sensitive data. For instance, the migration metadata may be a tag assigned to an uppermost layer of the new container image.

It follows that the TEE migration metadata and the extracted sensitive data may be included together in an individual layer of the new container image. In some situations, the individual layer is the uppermost layer of the new container image. This uppermost layer of the new image may serve as the image layer while layers below the uppermost image layer may be limited to read-only. Accordingly, the TEE migration metadata and the extracted sensitive data may be added to the uppermost image layer, as well as read therefrom, during use without impacting a remainder of the image. Similar functionality may also be achieved by assigning the migration metadata as a tag to the image itself, while the sensitive data is packaged in a layer of the image.

In yet another general approach, a computer program product includes a computer readable storage medium having program instructions embodied therewith. The program instructions are readable by a processor, executable by the processor, or readable and executable by the processor, to cause the processor to: perform any combination of the foregoing methodologies. It follows that computer program products are able to achieve the improvements described above by performing the combinations of the foregoing methodologies.

A particular application of an approach can be using the computer-implemented method(s) as described above to migrate sensitive data between different TEEs that are located in different clusters. For instance, a sensitive data migration request received at a first TEE from a remote second TEE may be directed to a container engine correlated with the first TEE. The container engine includes a migration layer consumer module that is configured to evaluate the sensitive data migration request received from the remote second TEE and satisfy the request. However, the container engine also preferably includes a migration layer producer module configured to generate sensitive data migration requests and send them to other TEEs. Container engines described in the various approaches herein are thereby able to achieve data migration without exposing any sensitive information outside protected environments that provide trusted execution and/or storage regions, which has been conventionally unachievable. Furthermore, this can be accomplished in a TEE-independent manner, thereby significantly expanding applicability of the improvements achieved by approaches herein.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product implementation (“CPP implementation” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved data migration code at block 150 for migrating highly sensitive (and sometimes encrypted) data across cloud confidential computing environments. In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

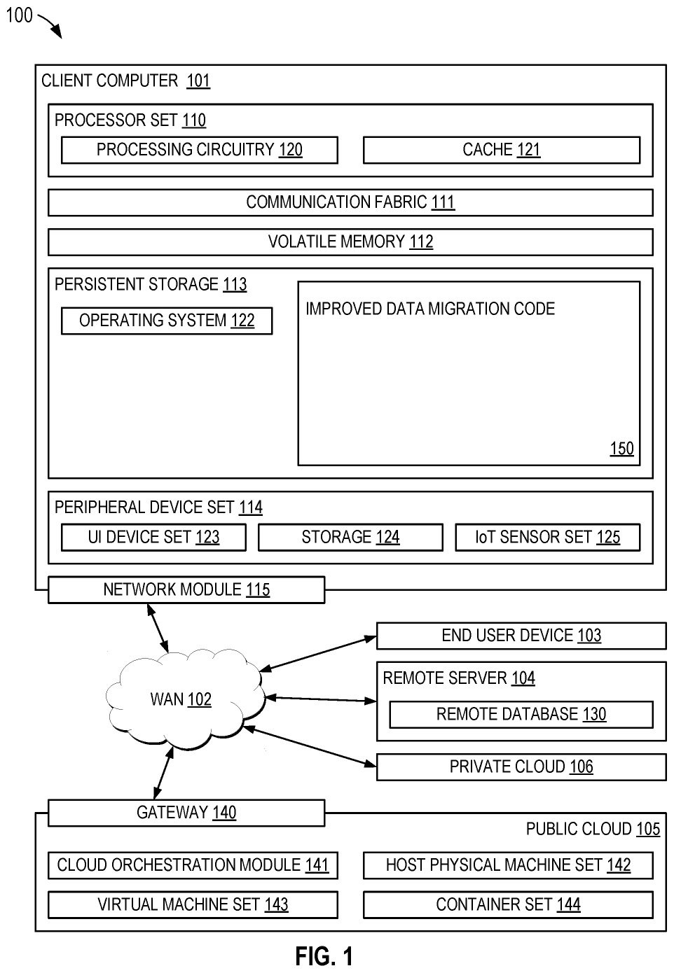

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some implementations, storage 124 may take the form of a quantum computing storage device for storing data in the form of qubits. In implementations where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some implementations, network control functions and network forwarding functions of network module 115 are performed on the same physical hardware device. In other implementations (for example, implementations that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some implementations, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some implementations, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other implementations a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various implementations may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various implementations.

As noted above, the use of public and hybrid cloud services continues to expand, causing data privacy in cloud environments to become increasingly important. In an attempt to address this, cloud providers have offered encryption services to help protect data while it is at rest (e.g., in storage and databases), as well as data that is in transit (e.g., moving over a network connection). However, encrypted data is decrypted while in use. For instance, before it can be processed by an application, data must be unencrypted in memory. This undesirably exposes sensitive information to exposure just before, during, and just after processing. Accordingly, it is desirable that confidential computing is able to provide greater assurances that data in cloud environments is protected and confidential.

Confidential computing attempts to solve these issues by further isolating sensitive data in a protected enclave during processing. Contents of the enclave, such as the data being processed, as well as the techniques used to process the data, are accessible only to authorized programming code. As a result, these contents are invisible and unknowable outside the protected enclave, e.g., even to a cloud provider providing the resources that enable the enclave.

For example, hardware-based trusted execution environments (TEEs) offer secure enclaves within processing components, e.g., such as a CPU. A TEE is secured using embedded encryption keys, and embedded attestation mechanisms are used to ensure that the keys are only accessible to authorized application code. If malware or other unauthorized code attempts to access the keys, or if the authorized code is altered in any way, the TEE denies access to the keys and cancels the computation. In this way, TEEs allow for sensitive data to remain protected in memory until it is decrypted for processing. Although the data is decrypted for use, it remains invisible throughout the entire computation process to the operating system, to other compute stack resources, and even cloud providers.

While TEEs have increased the security of data while in use, they provide limited accessibility, particularly in cloud computing environments. For instance, implementing containerized microservices in a TEE involves storing sensitive data in virtual volumes such that the sensitive data is only visible to the given microservice (or application) that is within the same TEE container. However, the sensitive data cannot be accessed from outside the container.

Conventional products have simply been unable to overcome this limitation and therefore cannot securely migrate data protected by TEE. The inability to externally access this confidential data, for migration or any other purposes, is actually implemented by design for security purposes. Thus, a need exists to be able to migrate sensitive data, while also adhering to all the security design and standards for confidential computing from one container to another. As a result, a need exists for improved data migration between protected environments.

In sharp contrast to these conventional shortcomings, approaches herein are able to migrate sensitive data while maintaining security of the data itself, even in cloud confidential computing environments. Additionally, this process is made transparent to the end user after providing a migration trigger, so as not to impact the user experience. Furthermore, this can be accomplished in a TEE-independent manner, thereby significantly expanding applicability of the improvements achieved by approaches herein, e.g., as will be described in further detail below.

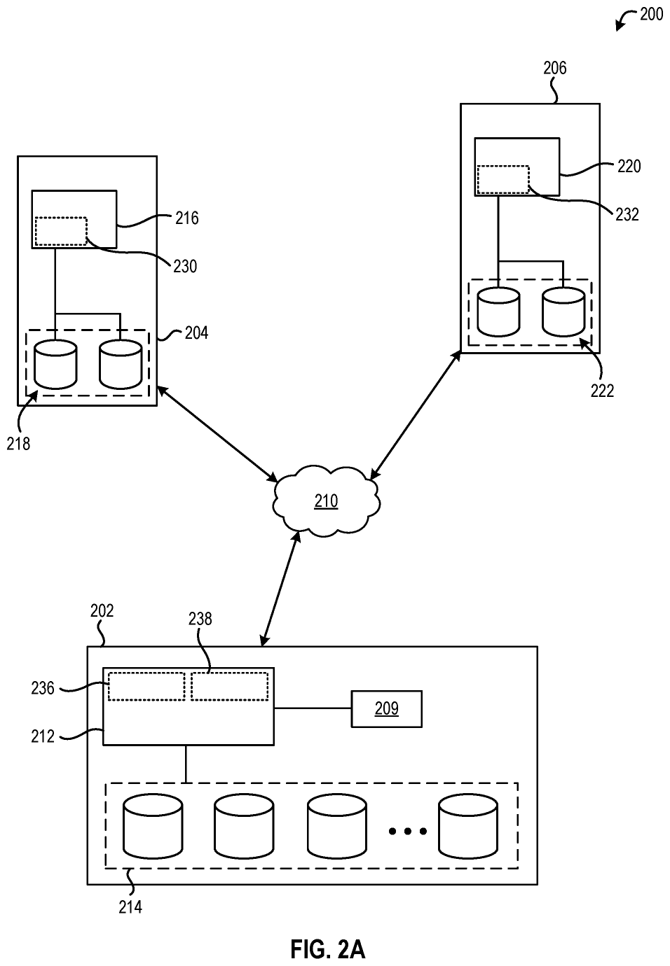

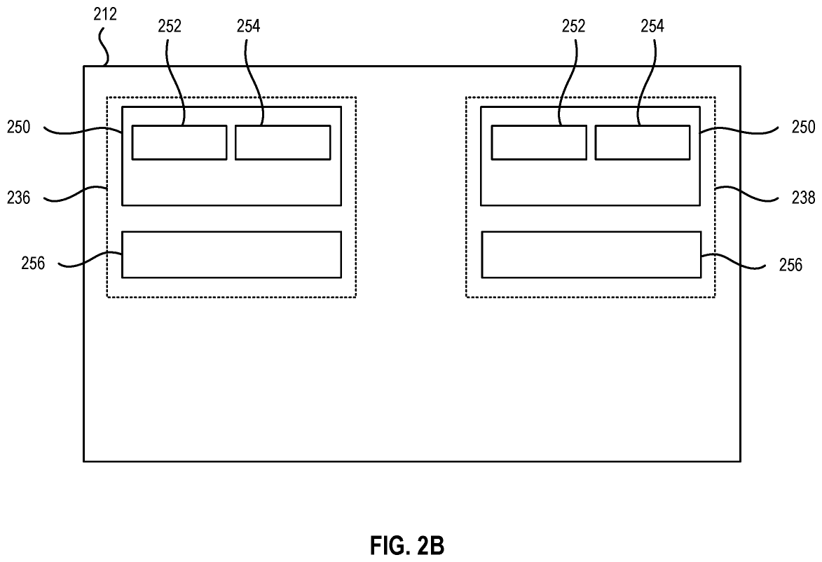

Looking now to FIGS. 2A-2B, a representational view of a distributed system 200 that is configured as a container orchestration platform is shown in accordance with one approach. Specifically, FIG. 2A provides a representational view of the physical components that are included in the distributed system 200 in accordance with one approach. FIG. 2B illustrates a more detailed view of one of the processors 212 in FIG. 2A.

As an option, the present system 200 may be implemented in conjunction with features from any other approach listed herein, such as those described with reference to the other FIGS. However, this system 200 and others presented herein may be used in various applications and/or in permutations which may or may not be specifically described in the illustrative approaches or implementations listed herein. Further, the system 200 presented herein may be used in any desired environment. Thus FIGS. 2A-2B (and the other FIGS.) may be deemed to include any possible permutation.

As shown, the system 200 includes a number of physical components therein. For instance, the system 200 is illustrated as including a central cluster 202 that is connected to a first cluster 204 and a second cluster 206. Specifically, the central cluster 202, first cluster 204, and second cluster 206 are each connected to a network 210. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc., may be sent between the clusters 204, 206, and/or 202, regardless of the amount of separation which exists therebetween, e.g., despite being positioned at different geographical locations.

It should also be noted that two or more of the clusters 204, 206, 202 may be connected to each other differently depending on the approach. According to an example, which is in no way intended to limit the invention, two or more edge clusters (e.g., compute nodes) may be located relatively close to each other and connected by a wired connection, e.g., a cable, a fiber-optic link, a wire, etc., or any other type of connection which would be apparent to one skilled in the art after reading the present description.

With continued reference to FIG. 2A, the first and second clusters 204, 206 may have a different configuration than the central cluster 202. For instance, the first and second clusters 204, 206 may be edge nodes, while the central cluster serves as a central node that offers scalable cloud computing and/or data storage. Accordingly, the first cluster 204 includes a processor 216 coupled to memory 218, and second cluster 206 includes a processor 220 coupled to memory 222, while central cluster 202 includes a large (e.g., robust) processor 212 that is coupled to a cache 209 and a data storage array 214 having a relatively high storage capacity (e.g., at least a higher storage capacity than the cache 209). The central cluster 202 is thereby able to process and store a relatively large amount of data, allowing it to be connected to, and manage, multiple different remote clusters (e.g., edge node servers).

Each of the processors 212, 216, 220 at the respective cluster locations 202, 204, 206 further include hardware-based TEEs 230, 232, 236, 238. As noted above, TEEs offer secure enclaves within processing components using embedded encryption keys. Embedded attestation mechanisms are used to ensure that the keys are only accessible to authorized application code. If malware or other unauthorized code attempts to access the embedded encryption keys, or if the authorized code is altered in any way, the corresponding TEE denies access to the keys and cancels the computation. In this way, each of the TEEs 230, 232, 236, 238 offer a protected region of the respective processors 212, 216, 220, thereby allowing for sensitive data to remain protected in use even after being decrypted from memory for processing. This is possible because even after the data is decrypted for use, each of the TEEs 230, 232, 236, 238 keep decrypted data invisible to the operating system (or hypervisor in a virtual machine setting), to other compute stack resources, and even cloud providers throughout the entire computation process, e.g., as would be appreciated by one skilled in the art after reading the present description.

Referring momentarily to FIG. 2B, the TEEs 236, 238 of processor 212 in central cluster 202 of FIG. 2A are shown in further detail. For instance, each of the TEEs 236, 238 include a container processing engine 250 (e.g., “container engine”). Each of the container processing engines 250 further include a migration layer producer module 252, a migration layer consumer module 254, as well as a graph driver module 256. The migration layer producer module 252 is preferably configured to generate new container images, e.g., based on received migration requests, while the migration layer consumer module 254 is configured to receive a container image and extract any sensitive information therefrom. The combination of the migration layer producer module 252 and migration layer consumer module 254 is thereby able to migrate sensitive data between protected TEEs while maintaining data security, which has been conventionally unachievable.

Again, although data remains protected while in use, conventional products have suffered from significantly reduced accessibility, particularly in certain environments. For instance, implementing containerized microservices in a TEE involves storing sensitive data in virtual volumes such that the sensitive data is only visible to the given microservice (or application) that is within the same TEE container. In other words, sensitive data cannot be accessed from outside the container. As a result, conventional products have been unable to offer the ability to migrate sensitive data in a virtual volume from outside the corresponding container. This inability to externally access confidential data, for migration or any other purposes, is actually implemented by design for security purposes in these conventional products. Thus, a need exists to be able to migrate sensitive data, while also adhering to security design and standards for confidential computing from one container to another.

In sharp contrast to these conventional shortcomings, approaches herein are able to migrate sensitive data while maintaining security of the data itself, even in cloud confidential computing environments. Additionally, this process is made transparent to the end user after providing a migration trigger (e.g., request), so as not to impact the user experience. Furthermore, this can be accomplished in a TEE-independent manner, thereby significantly expanding applicability of the improvements achieved by approaches herein, e.g., as will be described in further detail below.

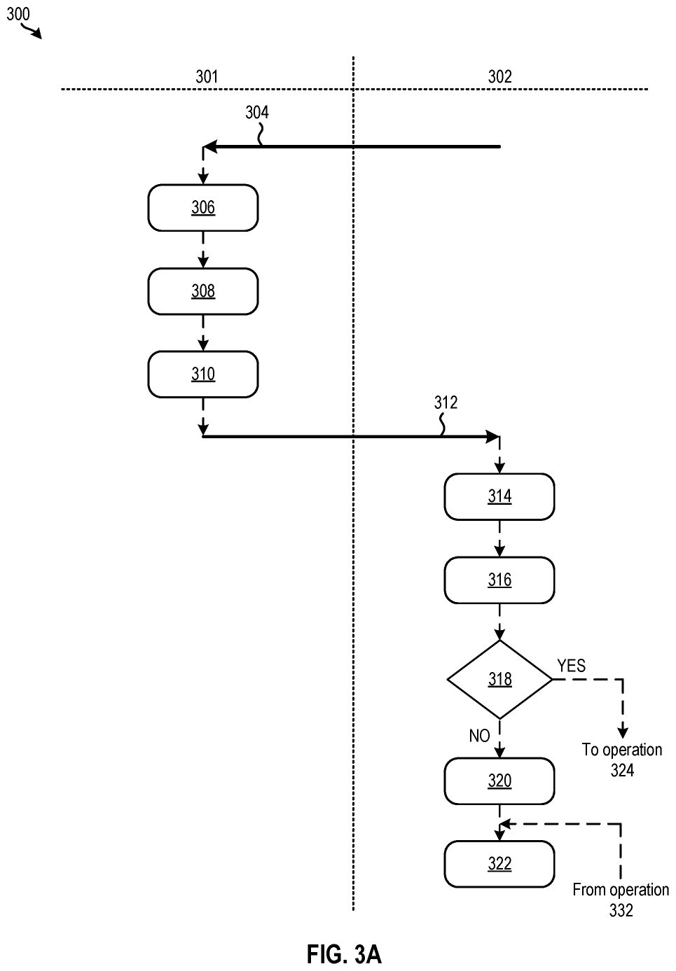

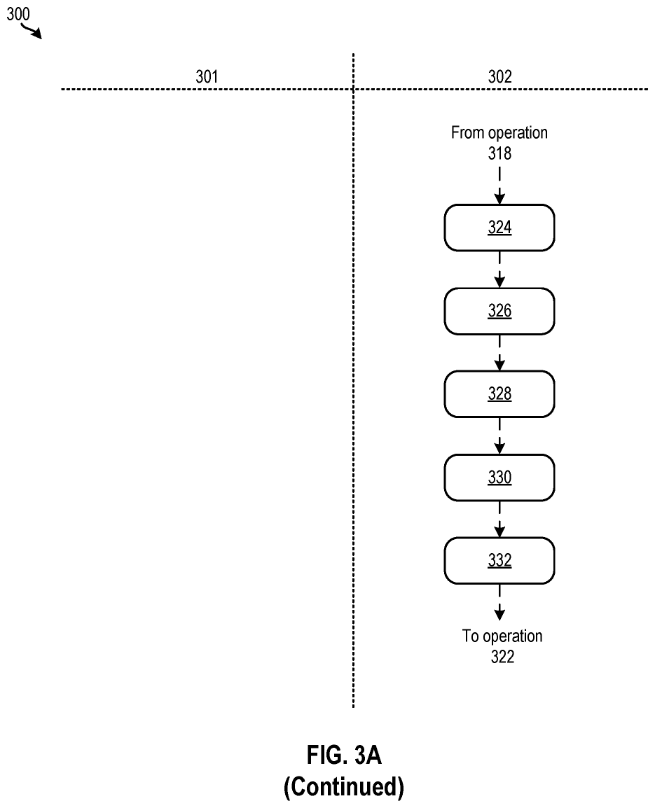

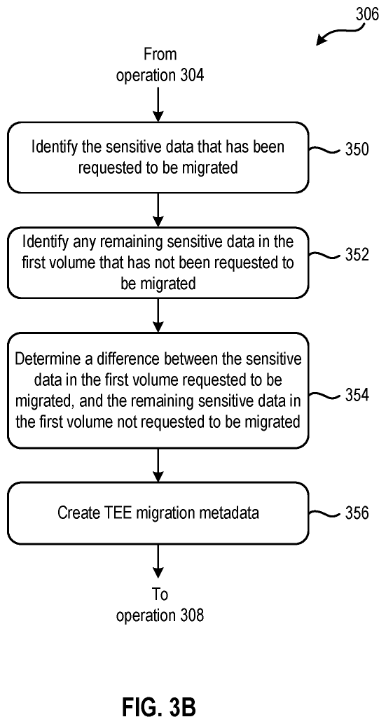

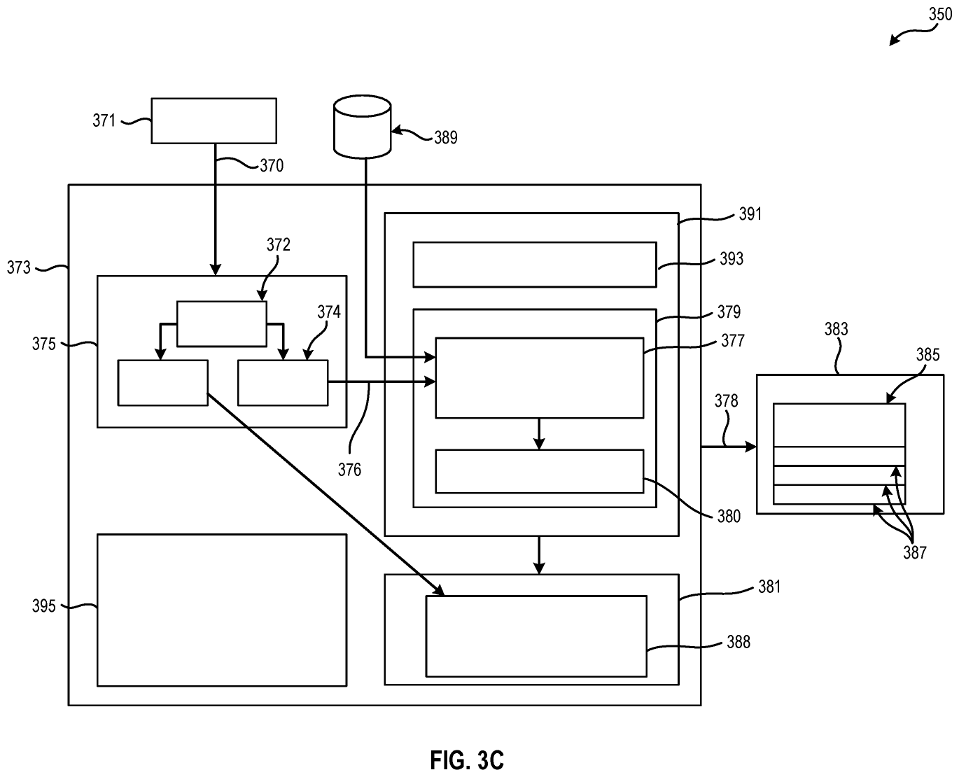

Referring now to FIG. 3A, a computer-implemented method 300 for migrating highly sensitive (and sometimes encrypted) data in cloud confidential computing environments is illustrated in accordance with one approach. This desirably avoids situations where sensitive data is inaccessible from outside the given container. The method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment. Each of the nodes 301, 302 shown in the flowchart of method 300 may correspond to one or more processors, controllers, computers, etc., positioned at a different node of a distributed system. For instance, node 302 may include one or more processors at client locations of a distributed system (e.g., see remote clusters 204, 206 of FIGS. 2A-2B above). Furthermore, node 301 may include one or more processors which are located at a central server configured to manage a distributed system (e.g., see central cluster 202 of FIGS. 2A-2B above). It follows that commands, data, requests, etc. may be sent between each of the nodes 301, 302 depending on the approach. Moreover, it should be noted that the various processes included in method 300 are in no way intended to be limiting, e.g., as would be appreciated by one skilled in the art after reading the present description. For instance, data sent from node 302 to node 301 may be prefaced by a request sent from node 301 to node 302 in some approaches.

In various implementations, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Looking specifically now to the flowchart, data may be migrated between TEEs in certain situations. For instance, data housed in a first TEE may be referenced by an application running in a different TEE. As noted above, containerization has increased the importance of being able to easily migrate data between distributed physical and/or logical locations. Operation 304 thereby includes sending a migration request from node 302 to node 301. More specifically, operation 304 includes sending a migration request that involves migrating specific sensitive data from a first volume in a first TEE at node 301, to a second volume in a second TEE at node 302. Depending on the approach, the migration request may originate from a user, an application running in a remote container of a different TEE, a remote storage location, etc. As noted above, the term “sensitive data” as used herein may refer to any type of data for which access to the data is to be restricted and/or controlled in some way. For example, sensitive data may include confidential data, data that is to remain within an organization and not shared outside the organization, data that is not to be made available to the public, data that a user wishes to keep private, data that is subject to a higher standard of care as a result of applicable legislation and/or corporate policies (e.g., data associated with children under 13 years of age as specified by the Children's Online Privacy Protection Act), data that is provided confidentially to another user or entity, etc. In a preferred approach, sensitive data may be data that is only accessible by a computer and/or user that is authorized to access such data. In another approach, sensitive data may be data designated as sensitive data, e.g., by a user who stored the data, by an organization in which the data is created and/or stored, etc. In still another approach, certain types of data may automatically be identified by one or more running applications as being sensitive data. Additionally, the term “data” is in no way intended to be limiting. Thus, “sensitive data” may include any desired type of information, e.g., such as signals received from sensors, metadata that provides context to the characters or symbols on which operations are performed by a computer, text entered by a user that has been converted into a binary representation, outputs (or results) of an application that is run, etc. Further still, the sensitive data may be stored, transported, used (e.g., processed), etc., in desired formats. For example, sensitive data may be stored in an encrypted format as encrypted information, and decrypted before being processed. According to another example, sensitive data may be compressed before being encrypted for storage in memory, thereby improving the storage capacity of memory as a whole.

With continued reference to FIG. 3A, it should also be noted that the source of the migration request (here node 302) is aware that the desired data is actually protected in a TEE at node 301. The request sent in operation 304 may thereby be sent in some approaches as a result of accessing a hidden (e.g., encrypted) lookup table that indicates where protected data is currently located. In some approaches, a migration request is sent in association with a “microservice data migration” which is intended to refer to the process of transferring, transforming, and managing data while transitioning from one version of a microservice to another, e.g., as would be appreciated by one skilled in the art after reading the present description.

In response to receiving the migration request at node 301, the request is evaluated to determine details associated with the data being requested. Operation 306 thereby includes generating TEE migration metadata that outlines the sensitive data being requested from the TEE at node 301. In other words, TEE migration metadata is produced which identifies the specific data requested for migration from the TEE at node 301. With respect to the present description, “migration metadata” is intended to include any type of information that is able to outline which data in a volume of a TEE should be migrated. For example, in some approaches the TEE migration metadata includes key-value character strings that identify the actual location of the sensitive data requested to be migrated. Moreover, the TEE migration metadata may be in the form of key-value character strings that can be assigned to an image layer during image committing to keep the migration data information.

It follows that the process of generating TEE migration metadata may vary depending on the type of data being migrated, where the data is being migrated from, where the data is being migrated to, etc. Referring momentarily now to FIG. 3B, exemplary sub-operations of generating TEE migration metadata are illustrated in accordance with one approach. One or more of these sub-operations may thereby be used to perform operation 306 of FIG. 3A. However, it should be noted that the sub-operations of FIG. 3B are illustrated in accordance with one approach which is in no way intended to limit the invention.

As shown, sub-operation 350 of FIG. 3B includes identifying the sensitive data that has been requested to be migrated. In preferred approaches, the sensitive data is identified by determining the location in a volume that the sensitive data resides. As noted above, the location of the sensitive data may be quantified using one or more key-value character strings that describe where the sensitive data is positioned in a volume. The volume is further correlated with a container that may be determined as a part of sub-operation 350 to identify the sensitive data. In some approaches, identifying information may be received in the initial migration request. For instance, the migration request may include key-value character strings that define the boundaries of the sensitive data (e.g., the extents of a file) being migrated. The migration request may thereby be evaluated in some approaches to perform sub-operation 350, e.g., as would be appreciated by one skilled in the art after reading the present description.

Migration requests sometimes do not involve migrating all the data in a volume corresponding to a TEE. Rather, at least some of the data in a volume may not pertain to the migration request. Thus, in addition to identifying the data that has been requested to be migrated, sub-operation 352 includes identifying any remaining sensitive data in the first volume that has not been requested to be migrated. As noted above, the data that has not been requested to be migrated may be identified using key-value character strings that correspond to the volume in which the data in question is located. In some approaches, any data not identified in sub-operation 350 may automatically be determined as not having been requested.

It follows that sub-operation 350 includes generating “IncludeFiles” which contain all the files on the volume that are to be migrated, while sub-operation 352 includes generating “ExcludePatterns” that outline the files that do not need to be migrated from the volume. Again, data in a volume may be identified (e.g., referenced) differently depending on the approach. Thus, although some approaches use key-value character strings to define the boundaries of sensitive data that is to be migrated or not migrated from a volume in a TEE, the data may be referenced differently.

Referring still to FIG. 3B, sub-operation 354 includes determining a difference between the sensitive data in the first volume requested to be migrated, and the remaining sensitive data in the first volume not requested to be migrated. In other words, sub-operation 354 includes comparing the sensitive data identified in sub-operation 350, with the sensitive data identified in sub-operation 352. This may involve comparing the key-value character strings to determine which data should be extracted (e.g., copied) from the volume, as well as which data should be maintained in the volume (e.g., ignored).

Furthermore, the difference(s) identified in sub-operation 354 are used to create the TEE migration metadata. See sub-operation 356. In other words, sub-operation 356 includes converting the IncludeFiles and ExcludePatterns into the TEE migration metadata. The TEE migration metadata may thereby be used to identify (i) portions of a volume correlated with a TEE that should be migrated to a different volume in a new TEE, and (ii) remaining portions of the same volume that should not be migrated to the different volume in the new TEE. It follows that the sub-operations of FIG. 3B are successfully able to identify and reference sensitive data in a volume of a TEE based on details provided in an initial migration request.

Returning now to FIG. 3A, method 300 proceeds from operation 306 to operation 308 in response to generating the TEE migration metadata that outlines the sensitive data that has been requested to be migrated from a first volume of a first TEE. There, operation 308 includes extracting the sensitive data from the first volume of the first TEE. With respect to the present description, sensitive data may be “extracted” from a volume by actually removing the data from the volume, generating a copy of the data that remains in the volume, replacing the data in the volume with different data, etc.

However, the sensitive data is extracted from the volume of the TEE at node 301 without exposing the data outside a protected environment. It should be noted that with respect to the present description, a “protected environment” is intended to refer to an environment that is able to offer secure enclaves within processing components and/or memory. One example of a protected environment, which is in no way intended to be limiting, is a TEE, e.g., as would be appreciated by one skilled in the art after reading the present description.

Operation 310 further involves generating a new container image which includes the TEE migration metadata and the extracted sensitive data packaged therein. In some approaches, operation 310 includes packaging the TEE migration metadata and the extracted sensitive data together in an individual layer of a newly generated container image. For example, the TEE migration metadata may be packaged with the sensitive data in an uppermost layer of the container image generated at operation 310. However, in other approaches, the container image generated in operation 310 includes the TEE migration metadata assigned to the image itself, while the sensitive data is packaged in a layer of the image. For instance, the sensitive data may be packaged in the uppermost layer of the container image, while the TEE migration metadata is assigned to the image itself (e.g., as a tag). It follows that the TEE migration metadata as used herein may be assigned to a container image and/or a layer of a container image depending on the desired approach.

It follows that in some approaches, the TEE migration metadata and the extracted sensitive data are packaged together in an individual layer of the new container image, ideally the uppermost layer of the new container image. This uppermost layer of the new image may serve as the image layer while layers below the uppermost image layer may be limited to read-only. These read-only layers may be originally added to the base image using a code that allows them to run in a container, e.g., as would be appreciated by one skilled in the art after reading the present description. Accordingly, the TEE migration metadata and the extracted sensitive data may be added to the uppermost image layer, as well as read therefrom, during use. As noted above, in other approaches, the TEE migration metadata may simply be an image tag that has been assigned to the uppermost layer of the new container image. However, the TEE migration metadata and/or the extracted sensitive data itself may be implemented differently depending on the approach.

From operation 310, method 300 advances to operation 312. There, operation 312 includes sending the new container image from the source TEE at node 301, to the target TEE at node 302. A TEE that is local to (e.g., located at) node 302 is thereby able to receive container images from a remote TEE at node 301 in correspondence with migration requests. This allows for sensitive data to be migrated between protected environments without exposing the data.

In response to receiving the container image at node 302, operation 314 includes creating (e.g., initializing) a private registry, while operation 316 includes inspecting the new container image. For instance, operation 316 may include evaluating information that may be packaged in an uppermost layer of the received container image.

Method 300 further proceeds to operation 318 in response to evaluating the new container image. There, operation 318 determines whether the received container image includes any TEE migration metadata. In other words, operation 318 includes determining whether the received container image indicates that sensitive data is being migrated between TEEs. As noted above, this may be accomplished at least in part by inspecting an uppermost layer of the received container image in some approaches. In other approaches, the image itself may be inspected for any TEE migration metadata that may be assigned thereto.

In situations where TEE migration metadata is not present in the container image, it can be deduced that the container image received at node 302 does not correspond to a data migration between TEEs. In other words, the absence of TEE migration metadata in a received container image may indicate that non-sensitive data is being migrated between non-protected volumes. Thus, in response to determining that TEE migration metadata is not present, method 300 proceeds to operation 320. There, operation 320 includes using the received container image to create a corresponding container at node 302. Again, the container created in operation 320 does not correspond to any protected regions of memory and/or processing. This container may thereby be created using nominal processes, e.g., as would be appreciated by one skilled in the art after reading the present description.

Once the container has been created, the migration request originally received at operation 304 may effectively be satisfied. However, additional steps may be taken to integrate the container with the logical environment at the target location of node 302. For example, the container may be added to a lookup table that lists all the entities (e.g., containers, corresponding volumes, etc.) that are located at node 302.

From operation 320, the flowchart of FIG. 300 proceeds to operation 322, whereby method 300 may end. However, it should be noted that although method 300 may end upon reaching operation 322, any one or more of the processes included in method 300 may be repeated in order to satisfy additional data migration requests. In other words, any one or more of the processes included in method 300 may be repeated for subsequently received data migration requests.

Returning now to operation 318, method 300 proceeds to operation 324 in response to determining that TEE migration metadata is present in the received container image. In other words, method 300 proceeds to operation 324 in situations where it is determined that the received container image corresponds to a migration of sensitive data between secured processing environments. There, operation 324 includes parsing information in the uppermost layer of the container image, while operation 326 includes extracting any information from the uppermost layer. As noted above, the uppermost layer of the container image formed in operation 310 is used to store sensitive data being migrated, as well as the TEE migration metadata that identifies the extents of the data being migrated.

It follows that operation 324 includes inspecting the received container image and evaluating any details included therein. For instance, information in the uppermost layer of the container image may be parsed before being extracted. Accordingly, operation 326 includes extracting any: sensitive data currently being migrated, TEE migration metadata corresponding to a source and/or target of the sensitive data being migrated, supplemental information received along with the initial migration request, etc., or any other details that are packaged in the received container image. This information may be parsed and extracted from the uppermost layer of the received container image in some approaches. This allows for node 302 to gain insight on the sensitive data being migrated between protected environments, without exposing the data itself to improper access.

In response to extracting the information from the container image received at node 302, method 300 proceeds to operation 328. There, operation 328 includes establishing an identification for the container image. In some approaches, extracting the information from the uppermost layer removes the uppermost layer from the container image altogether. Thus, the second layer of the container image may be set as the identification for the container image simply by designating the second layer as a new image layer for the container image. In other approaches, the uppermost layer may remain in the container image despite having any details extracted therefrom in operation 324. In such approaches, the second layer may be set as the identification for the container image by ignoring (e.g., downgrading) the emptied uppermost layer, while promoting the second layer of the container image. In some approaches, the second layer is promoted to a new uppermost layer of the container image.

It should be noted that use of the term “uppermost” herein is in no way intended to be limiting. Rather than using the uppermost layer of a container image to store sensitive data being migrated, migration metadata (e.g., target volume location for the data being migrated), etc., this information may be stored in one or more other layers of a container image that provide equivalent functionality. Additionally, use of the term “second” layer is in no way intended to be limiting. In preferred approaches, the second layer is the layer immediately below the uppermost layer of the container image. However, any desired layer(s) in the container image may be promoted to the identification of the container image, e.g., depending on the approach.

Proceeding now to operation 330, the second layer of the container image is used to generate a corresponding container at node 302. Although the container image may have been received with protected information (e.g., sensitive data, TEE migration metadata, indicator flags, etc.) in the uppermost layer, using information in the second layer to create a container prevents any exposure of the protected information. In other words, by stripping any protected information from the container image before using the image to create a container at node 302 allows for the protected information to be migrated to the target location while remaining hidden, e.g., as would be appreciated by one skilled in the art after reading the present description. The container is also preferably generated such that it is correlated with the target volume of the sensitive data being migrated. For instance, in some approaches the received container image is loaded from disk into memory to effectively create a corresponding container. Moreover, an uppermost layer of the resulting container may function as the read/write layer. This allows for sensitive data to be stored in an uppermost layer of the resulting container, e.g., as will soon become apparent.

In response to creating the container at node 302, method 300 advances from operation 330 to operation 332. There, operation 332 includes inserting the sensitive data that was extracted from the received container image, into an uppermost layer of the formed container. In other words, operation 332 includes inserting the sensitive data being migrated—from a volume in a first TEE at node 301 to a volume in a second TEE at node 302—into a read/write layer of the container formed in operation 330. This effectively completes the data migration by incorporating the sensitive data in the newly formed container at the target location. Accordingly, method 300 is shown as returning to operation 322 from operation 332. However, additional operations may be performed before method 300 is ended in some approaches. For instance, a notification indicating that the data migration was completed successfully may be generated and returned to node 301 (not shown). It should also be noted that the data being migrated may be encrypted while stored in a virtual volume. Accordingly, the process of packaging the sensitive data in the uppermost layer of a newly formed container image may involve decrypting and/or encrypting the data. Similarly, the process of evaluating and implementing a received container image at a target TEE may involve decrypting and/or encrypting the data, e.g., as would be appreciated by one skilled in the art after reading the present description.

The operations of method 300 are able to accomplish this data migration without exposing any sensitive information outside protected environments that provide trusted execution and/or storage regions. As a result, approaches herein are desirably able to migrate sensitive data while maintaining security of the data itself, even in cloud confidential computing environments. Additionally, this process is made transparent to the end user after providing a migration trigger, so as not to impact the user experience. Furthermore, this can be accomplished in a TEE-independent manner, thereby significantly expanding applicability of the improvements achieved by approaches herein. It should also be noted that the operations shown as being performed at node 302 in FIG. 3A are preferably performed by a migration layer producer module (e.g., see 252 of FIG. 2B above), while the operations shown as being performed at node 301 in FIG. 3A are preferably performed by a migration layer consumer module (e.g., see 254 of FIG. 2B above).

Again, the migration layer producer module is preferably configured to generate TEE migration metadata as well as new container images as described herein based on received migration requests. The new container images indicate the data being migrated using TEE migration metadata (e.g., key-value character strings) that are assigned to the image layer during the image committing. The migration layer consumer module is configured to receive a container image, extract sensitive information therefrom, and use the extracted information to create new containers at a target TEE by using the second layer of the received image. However, this is in no way intended to be limiting, and different ones of the producer and consumer modules may be utilized at a given location based on whether the location is a source of data being migrated, or a target for migrated data, e.g., as would be appreciated by one skilled in the art after reading the present description.

Referring now to FIG. 3C, a flowchart of processing a migration request that involves relocating sensitive data from a source location to a target location is illustrated in accordance with an in-use example, which is in no way intended to be limiting. Rather, the details in FIG. 3C are intended to provide context as to how one or more of the operations in method 300 may be performed in certain situations. For example, FIG. 3C is described as implementing containerized microservices using Docker™ based technology to provide a context and to assist the reader. It follows that any one or more of the operations described below with respect to FIG. 3C may be implemented while performing at least some of method 300 in FIG. 3A. However, it should be appreciated that various approaches herein can be implemented by incorporating a wide range of containerization platforms, including for example containerization technologies such as Podman, Buildah, Containerd, etc.

Looking to FIG. 3C, a Docker commit request 371 is received at operation 370. The received request includes a “-v” commit which indicates that a migration of sensitive data has been requested from a volume in one TEE to another volume in a different TEE. The “-v” commit includes file path information that describes the location of the data that is requested to be migrated. For instance, the file path information may include key-value character strings that identify the sensitive data in the volume requested to be migrated from the first TEE. The received request also indicates that a “POST” restful type should be applied during the data migration, e.g., as would be appreciated by one skilled in the art after reading the present description.

In response to receiving the commit request, a Docker™ engine 373 passes the request to a migration layer producer module 375. The Docker™ engine 373 also includes a migration layer consumer module 395 that may be used to process received container images, e.g., as described herein. The migration layer producer module 375 checks and parses the migration details included in the received commit request at operation 372, while operation 374 includes identifying the “IncludeFile” (i.e., the specific data in a volume of a source TEE that has been requested to be migrated) as well as the “ExcludePatterns” (i.e., the specific data in a same volume of the source TEE that has not been requested to be migrated). This provides an accurate understanding of which data (e.g., files) in the volume at the source TEE should be migrated to a volume in a target TEE.

Looking to operation 376, the migration layer producer module 375 updates TarWithCoptions in the differentiation module 377 of DiffDriver 379. In other words, the IncludeFile and ExcludePatterns information is sent from the migration layer producer module 375 to a module 377 that is able to differentiate between the data that should be migrated, and the data that should not be migrated. The data requested to be migrated is also received at module 377 from the virtual volume 389 in the TEE that the data is being migrated from. Moreover, this information is passed to the application module 380 of the DiffDriver 379. There, the application module 380 produces an archive of the changes between the specified layer and the parent layer, based at least in part on the IncludeFiles and ExcludePatterns received from the migration layer producer module 375. It should be noted that the DiffDriver 379 is part of an overarching GraphDriver package 391 which also includes a ProtoDriver 393, e.g., as would be appreciated by one skilled in the art after reading the present description.

Returning to the migration layer producer module 375, data obtained as a result of parsing the received commit request is further used to generate a TEE migration tag. See operation 378. In other words, operation 378 involves the migration layer producer module 375 generating TEEMigrationData tag based on the parsed migration option. The generated TEEMigrationData tag is sent to an image packaging module 381 which is used to generate a corresponding container image. In other words, the migration layer producer module 375 assigns the TEEMigrationData tag to a new container image by utilizing a set method in the StoreBackend module 388. The TEEMigrationData tag is assigned to the top image layer in preferred approaches and identifies the data (e.g., files) in a source volume that are being migrated, as well as the data in the source volume that is not being migrated.

In response to assigning the TEEMigrationData tag to a container image, the Docker™ engine 373 generates a new container image 383 that includes TEEMigrationData and volume data as an individual layer 385 on top of all base image layers 387 in the newly formed container image 383. It follows that the newly formed container image 383 includes sensitive volume data as well as TEEMigrationData (also referred to herein as “TEE migration metadata”) in an uppermost layer 385 of the newly formed container image 383 The newly formed container image 383 is further sent from the Docker™ engine 373 to the migration layer consumer module in a different Docker™ engine (not shown), e.g., using any of the approaches described above with respect to FIGS. 3A-3B. As noted above, it follows that each Docker™ engine includes a migration layer producer module as well as a migration layer consumer module. Moreover, the migration layer producer module may be used to generate new container images, e.g., based on received migration requests, while the migration layer consumer module is configured to receive a container image and extract any sensitive information therefrom. The combination of the migration layer producer module and migration layer consumer module is thereby able to migrate sensitive data between protected TEEs while maintaining data security, which has been conventionally unachievable.

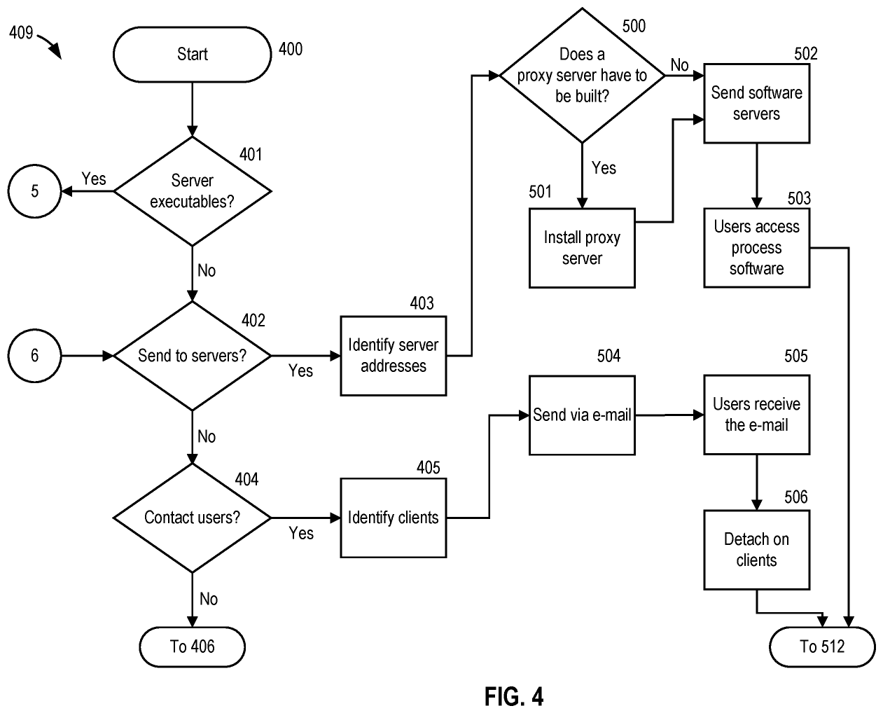

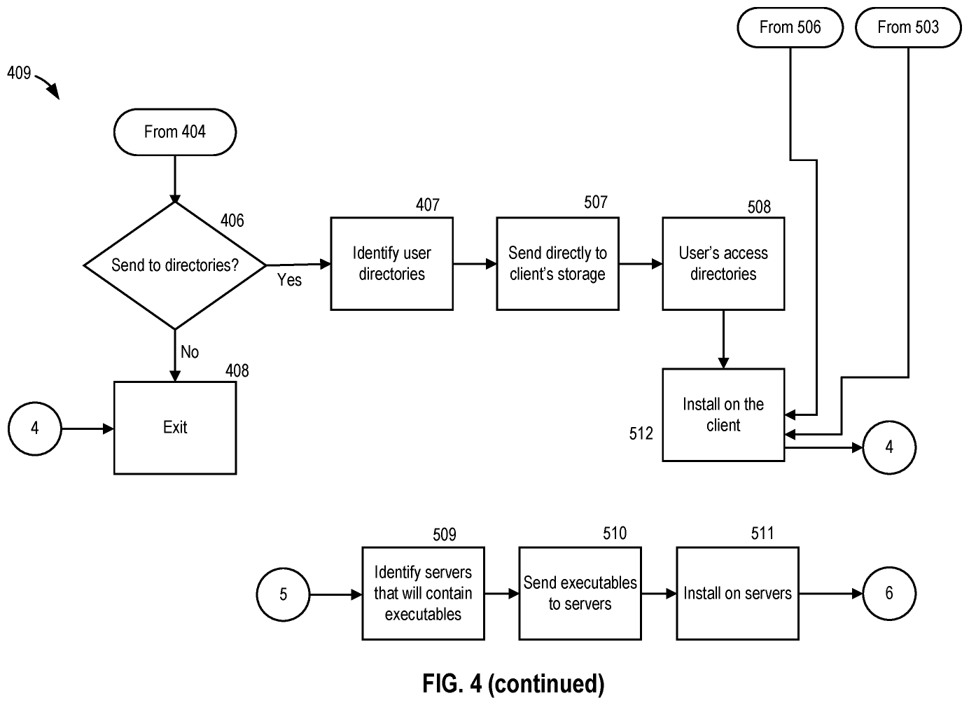

It should also be noted that software for performing the methodology of FIGS. 3A-3C may be deployed to a computer that is used to perform the various operations of the method via any known technique(s). An exemplary process for such deployment is presented immediately below with respect to FIG. 4.

Now referring to FIG. 4, a flowchart of a method 409 is shown according to one approach. The method 409 may be performed in accordance with the present invention in any of the environments depicted in FIGS. 1-3B, among others, in various approaches. Of course, more or fewer operations than those specifically described in FIG. 4 may be included in method 409, as would be understood by one of skill in the art upon reading the present descriptions.

Each of the steps of the method 409 may be performed by any suitable component of the operating environment. For example, in various approaches, the method 409 may be partially or entirely performed by a processing circuit, e.g., such as an IaC access manager, or some other device having one or more processors therein. The processor, e.g., processing circuit(s), chip(s), and/or module(s) implemented in hardware and/or software, and preferably having at least one hardware component, may be utilized in any device to perform one or more steps of the method 409. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software associated with migrating highly sensitive (and sometimes encrypted) data across cloud confidential computing environments, may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

With continued reference to method 409, step 400 begins the deployment of the process software. An initial step is to determine if there are any programs that will reside on a server or servers when the process software is executed 401. If this is the case, then the servers that will contain the executables are identified 509. The process software for the server or servers is transferred directly to the servers' storage via FTP or some other protocol or by copying through the use of a shared file system 510. The process software is then installed on the servers 511.

Next, a determination is made on whether the process software is to be deployed by having users access the process software on a server or servers 402. If the users are to access the process software on servers, then the server addresses that will store the process software are identified 403.

A determination is made if a proxy server is to be built 500 to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed 501. The process software is sent to the (one or more) servers either via a protocol such as FTP, or it is copied directly from the source files to the server files via file sharing 502. Another approach involves sending a transaction to the (one or more) servers that contained the process software, and have the server process the transaction and then receive and copy the process software to the server's file system. Once the process software is stored on the servers, the users, via their client computers, then access the process software on the servers and copy to their client computers file systems 503. Another approach is to have the servers automatically copy the process software to each client and then run the installation program for the process software at each client computer. The user executes the program that installs the process software on the client computer 512 and then exits the process 408.

In step 404 a determination is made whether the process software is to be deployed by sending the process software to users via e-mail. The set of users where the process software will be deployed are identified together with the addresses of the user client computers 405. The process software is sent via e-mail 504 to each of the users' client computers. The users then receive the e-mail 505 and then detach the process software from the e-mail to a directory on their client computers 506. The user executes the program that installs the process software on the client computer 512 and then exits the process 408.

Lastly, a determination is made on whether the process software will be sent directly to user directories on their client computers 406. If so, the user directories are identified 407. The process software is transferred directly to the user's client computer directory 507. This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software 508. The user executes the program that installs the process software on the client computer 512 and then exits the process 408.

It will be clear that the various features of the foregoing systems and/or methodologies may be combined in any way, creating a plurality of combinations from the descriptions presented above.

It will be further appreciated that approaches herein may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A computer-implemented method, comprising:
receiving a request to migrate sensitive data from a first volume in a first trusted execution environment (TEE) to a second volume in a second TEE;
generating migration metadata that outlines the sensitive data;
extracting the sensitive data from the first volume;
generating a new container image having the migration metadata and the sensitive data packaged therein; and
sending the new container image to the second TEE.

2. The computer-implemented method of claim 1, wherein the migration metadata includes key-value character strings that identify the sensitive data requested to be migrated.

3. The computer-implemented method of claim 1, wherein generating migration metadata that outlines the sensitive data, includes:
identifying the sensitive data in the first volume requested to be migrated;
identifying remaining sensitive data in the first volume not requested to be migrated;
determining a difference between (i) the sensitive data in the first volume requested to be migrated, and (ii) the remaining sensitive data in the first volume not requested to be migrated; and
using the difference to create the migration metadata.

4. The computer-implemented method of claim 1, wherein the migration metadata and the sensitive data are packaged in an individual layer in the new container image.

5. The computer-implemented method of claim 4, wherein the migration metadata is an image tag assigned to an uppermost layer of the new container image.

6. The computer-implemented method of claim 1, wherein the operations are performed by a migration layer producer module in a container engine at the first TEE.

7. The computer-implemented method of claim 6, wherein the container engine includes the migration layer producer module and a migration layer consumer module.

8. The computer-implemented method of claim 7, wherein the migration layer consumer module is configured to:
receive a container image from a remote TEE;
parse migration metadata in an uppermost layer of the container image;
extract data from the uppermost layer of the container image;
set a second layer of the container image as an identification for the container image;
use the second layer of the container image to generate a corresponding container; and
insert the extracted data into a read/write layer of the corresponding container.

9. A computer-implemented method, comprising:
receiving a container image from a remote trusted execution environment (TEE);
in response to determining that the received container image includes migration metadata therein, parsing the migration metadata;
extracting sensitive data from an uppermost layer of the container image;
setting a second layer of the container image as an identification for the container image;
using the second layer of the container image to generate a corresponding container; and
inserting the sensitive data into a read/write layer of the corresponding container.

10. The computer-implemented method of claim 9, wherein the container image is received at a local TEE from the remote TEE corresponding to a migration request.

11. The computer-implemented method of claim 9, wherein the operations are performed by a migration layer consumer module in a container engine.

12. The computer-implemented method of claim 11, wherein the container engine includes the migration layer consumer module and a migration layer producer module.

13. The computer-implemented method of claim 9, wherein the migration metadata includes key-value character strings that identify the sensitive data.

14. The computer-implemented method of claim 13, wherein the migration metadata is a tag assigned to the uppermost layer of the container image.

15. A computer program product, comprising a computer readable storage medium having program instructions embodied therewith, the program instructions readable by a processor, executable by the processor, or readable and executable by the processor, to cause the processor to:
receive a request to migrate sensitive data from a first volume in a first trusted execution environment (TEE) to a second volume in a second TEE;
generate migration metadata that outlines the sensitive data;
extract the sensitive data from the first volume;
generate a new container image having the migration metadata and the sensitive data packaged therein; and
send the new container image to the second TEE.

16. The computer program product of claim 15, wherein generating migration metadata that outlines the sensitive data, includes:
identifying the sensitive data in the first volume requested to be migrated;
identifying remaining sensitive data in the first volume not requested to be migrated;
determining a difference between (i) the sensitive data in the first volume requested to be migrated, and (ii) the remaining sensitive data in the first volume not requested to be migrated; and
using the difference to create the migration metadata.

17. The computer program product of claim 15, wherein the migration metadata and the sensitive data are packaged in an individual layer of the new container image, wherein the migration metadata is an image tag assigned to the new container image.

18. The computer program product of claim 15, wherein the operations are performed by a migration layer producer module in a container engine at the first TEE.

19. The computer program product of claim 18, wherein the container engine includes the migration layer producer module and a migration layer consumer module.

20. The computer program product of claim 19, wherein the migration layer consumer module is configured to:
receive a container image from a remote TEE;
parse migration metadata in an uppermost layer of the container image;
extract data from the uppermost layer of the container image;
set a second layer of the container image as an identification for the container image;
use the second layer of the container image to generate a corresponding container; and
insert the extracted data into a read/write layer of the corresponding container.
